(19) United States
(12) Patent Application Publication
(10) Pub. No.: US 2019/0284668 A1
(43) Pub. Date: Sep. 19, 2019

(54) ALUMINUM ALLOY SUBSTRATE FOR MAGNETIC DISC AND METHOD OF MANUFACTURE THEREFOR

(71) Applicants: UACJ CORPORATION, Tokyo (JP); FURUKAWA ELECTRIC CO., LTD., Tokyo (JP)

(72) Inventors: Takuya MURATA, Tokyo (JP); Kotaro KITAWAKI, Tokyo (JP); Makoto YONEMITSU, Tokyo (JP); Naoki KITAMURA, Tokyo (JP); Yasuo FUJII, Tokyo (JP); Tetsu SAKAI, Tokyo (JP); Hideki TAKAHASHI, Tokyo (JP); Takashi MORI, Tokyo (JP)

(21) Appl. No.: 16/349,850

(22) PCT Filed: Oct. 27, 2017
(86) PCT No.: PCT/JP2017/038913

§ 371 Date: May 14, 2019

(30) Foreign Application Priority Data
Nov. 15, 2016 (JP) 2016-221993

(51) Int. Cl. C22F 1/047; C22C 21/08; G11B 5/73; G11B 5/84

(52) U.S. Cl. CPC C22F 1/047; C22C 21/08; C22C 2202/02; G11B 5/8404; G11B 5/73919

(57) ABSTRACT

There are provided: an aluminum alloy substrate for a magnetic disk, including 2.0 to 10.0 mass % (hereinafter, simply referred to as “%”) of Mg, 0.003 to 0.150% of Cu, 0.05 to 0.60% of Zn, 0.03 to 1.00% of Mn, and 0.00001 to 0.00200% of Be, as well as Fe restricted to 0.50% or less, Si restricted to 0.50% or less, Cr restricted to 0.30% or less, and Cl restricted to 0.005% or less, with the balance of Al and unavoidable impurities; and a method of producing the aluminum alloy substrate for a magnetic disk.

### TECHNICAL FIELD

The present disclosure relates to an aluminum alloy substrate for a magnetic disk, specifically to an aluminum alloy substrate for a magnetic disk, excellent in plating property and grindability, and to a method of producing the aluminum alloy substrate for a magnetic disk, excellent in productivity.

### BACKGROUND ART

Magnetic disk substrates made of aluminum alloys, used in storage devices for computers and data centers, are produced by performing electroless Ni—P plating of aluminum alloy substrates according to MS 5086 (including 3.5 mass % or more and 4.5 mass % or less of Mg, 0.50 mass % or less of Fe, 0.40 mass % or less of Si, 0.20 mass % or more and 0.70 mass % or less of Mn, 0.05 mass % or more and 0.25 mass % or less of Cr, 0.10 mass % or less of Cu, 0.15 mass % or less of Ti, and 0.25 mass % or less of Zn with the balance of Al and unavoidable impurities) that have favorable plating properties and that are excellent in mechanical characteristics and workability, and by then polishing surfaces of the aluminum alloy substrates to be smooth, to deposit magnetic substances on the surfaces.

Further, magnetic disks made of aluminum alloys are produced, for example, with aluminum alloy substrates in which the contents of Fe, Si, and the like which are impurities in JIS 5086 are restricted to reduce the sizes of intermetallic compounds in a matrix for the purpose of improving pit defects due to falling-off of intermetallic compounds in a plating pretreatment step or with aluminum alloy substrates to which Cu and Zn in JIS 5086 are intentionally added for the purpose of improving plating properties.

Common magnetic disks made of aluminum alloys are produced by first producing an annular aluminum alloy substrate, plating the aluminum alloy substrate, and then depositing a magnetic substance on a surface of the aluminum alloy substrate.

For example, a magnetic disk made of an aluminum alloy, including the JIS 5086 alloy, is produced by the following production steps. First, an aluminum alloy allowed to contain desired chemical components is cast to obtain an ingot, and the ingot is subjected to homogenization treatment, then to hot rolling, and then to cold rolling, to produce a rolled material having a thickness required for the magnetic disk. It is preferable to anneal the rolled material in the cold rolling and/or the like as needed. Then, the rolled material is stamped to obtain aluminum alloy sheets having an annular shape. In order to eliminate distortion and/or the like occurring in the previous production steps, the aluminum alloy sheets having the annular shape obtained by stamping the rolled material are layered, and the resultant is subjected to pressurization annealing in which the resultant is flattened by annealing the resultant while pressurizing both top and under surfaces of the resultant. As a result, an annular aluminum alloy substrate is produced.

The annular aluminum alloy substrate produced in such a manner is subjected in turn to cutting work, grinding work, degreasing treatment, etching treatment, and zincate treatment (Zn substitution treatment) as pretreatment. Then, the annular aluminum alloy substrate is subjected to electroless plating with Ni—P which is a rigid non-magnetic metal as undercoat treatment, and a plated surface of the annular aluminum alloy substrate is polished, followed by sputtering a magnetic substance, to produce the magnetic disk made of an aluminum alloy.

In recent years, the larger capacities of HDDs have become necessary for the larger storage capacities of data centers, caused by development of cloud service, and for competition with SSDs which have been new storage devices. An increase in storage capacity per magnetic disk has been demanded for the larger capacities of the HDDs. The presence of defects such as pits on a Ni—P-plated surface results in the necessity of reading and writing data in portions other than the peripheries of the defects and therefore causes the storage capacity per magnetic disk to be decreased in proportion to the number of the defects. Therefore, a decrease in the defects on the Ni—P-plated surface is essential for increasing the storage capacity.

The defects on the Ni—P-plated surface are caused by holes formed by falling-off of an intermetallic compound from an aluminum alloy substrate or by holes formed by melting the aluminum alloy substrate due to local cell reaction between the aluminum alloy substrate and the intermetallic compound. Measures against such defects have been taken by decreasing the contents of Fe and Si in an aluminum alloy. However, a decrease in the contents of Fe and Si requires an increase in the amount of high-purity base metal used and thus causes a rise in cost. Further, an excessive decrease in the content of Fe results in a decrease in rate in grinding work, thereby deteriorating productivity. In other words, a decrease in the contents of Fe and Si for decreasing the number of defects on a plated surface results in a rise in cost and in the deterioration of productivity. Thus, a solution method which is different from such conventional methods and in which the number of defects on a plated surface can be decreased without decreasing the contents of Fe and Si has been demanded.

Fe and Si are solid-dissolved in an aluminum alloy substrate. However, Fe and Si incapable of being solid-dissolved exist as an Al—Fe-based intermetallic compound and an Al—Si-based intermetallic compound in the aluminum alloy substrate. In a case in which Mn has been added into an aluminum alloy, the intermetallic compounds form an Al—Fe—Mn-based intermetallic compound and an Al—Si—Mn-based intermetallic compound, respectively. Inhibition of local cell reaction due to a small potential difference between the intermetallic compounds and the matrix of the aluminum alloy substrate (hereinafter, simply referred to as “matrix”) causes the aluminum alloy substrate to be inhibited from being melted. As a result, the number of the defects on the plated surface can be decreased.

For example, Patent Literature 1 discloses the composition of an aluminum alloy substrate to which Mn is added to improve strength. Patent Literature 2 discloses a technology to control the composition ratio of elements in an Al—Fe—Mn-based intermetallic compound.

### CITATION LIST

### Patent Literature

Patent Literature 1: Japanese Patent No. 5815153
Patent Literature 2: Japanese Patent No. 5767384

### SUMMARY OF INVENTION

### Technical Problem

However, such conventional technologies have not reached a technological concept in which the number of defects on a plated surface is decreased by addition of Mn. Thus, such conventional technologies have been incapable of achieving a departure from such a technique of decreasing the number of defects on a plated surface by restricting the contents of Fe and Si to low levels as conventional techniques.

In the present disclosure made under such actual circumstances, addition of Mn in the composition of an aluminum alloy substrate inhibits an aluminum alloy substrate from being melted, to decrease the number of defects on a plated surface, whereby a grinding work rate is improved. Further, the addition of Mn enables the upper limits of the contents of Fe and Si to be relaxed, thereby simultaneously reducing the costs of raw materials. Until now, it has been impossible to achieve a departure from such a technique of reducing the contents of Fe and Si in order to decrease the number of defects on a plated surface. However, the present inventors repeated research, found such an effect caused by the addition of Mn, and achieved a technology to decrease the number of defects on a plated surface by the addition of the element, contrary to the conventional technologies.

### Solution to Problem

The present inventors repeated intensive research on the relationships between the contents of Mn, Fe, and Si, and defects on a plated surface and a grinding work rate. As a result, it was found that control of the ratio of the contents of Mn, Fe, and Si enables the simultaneous achievement of the inhibition of defects on a plated surface and the improvement of a grinding work rate. Further, it was found that a restriction on an Al—Fe—Mn—Si-based intermetallic compound can allow the defects on the plated surface to be inhibited and can cause an effect to be obtained due to the improvement of the grinding work rate. Thus, the present disclosure was achieved.

In other words, in the claim 1 in the present disclosure, an aluminum alloy substrate for a magnetic disk includes 2.0 to 10.0 mass % of Mg, 0.003 to 0.150 mass % of Cu, 0.05 to 0.60 mass % of Zn, 0.03 to 1.00 mass % of Mn, and 0.00001 to 0.00200 mass % of Be, as well as Fe restricted to 0.50 mass % or less, Si restricted to 0.50 mass % or less, Cr restricted to 0.30 mass % or less, and Cl restricted to 0.005 mass % or less, with a balance of Al and unavoidable impurities.

In claim 2 in the present disclosure, an Al—Fe—Mn—Si-based intermetallic compound having a longest diameter of 10 μm or more is present at a density of 1.00 particle/cm² or less, in accordance with claim 1.

In claim 3 in the present disclosure, 0.25<Mn content (mass %)/(Si content (mass %)+Fe content (mass %))<1.00 is satisfied, in accordance with claim 1 or 2.

In claim 4 in the present disclosure, a method of producing the aluminum alloy substrate for a magnetic disk according to any one of claims 1 to 3 includes: a molten metal adjustment step of adding a Mg raw material having a Cl content of 0.05 mass % or less to adjust a molten metal of an aluminum alloy; a casting step of casting the adjusted molten metal to obtain an ingot; a homogenization treatment step of homogenizing the cast ingot by heat treatment; a hot-rolling step of hot-rolling the ingot subjected to the homogenization treatment, to obtain a hot-rolled sheet; and a cold-rolling step of cold-rolling the hot-rolled sheet, wherein the homogenization treatment step includes: a first heating stage of heating the ingot at a temperature of 400° C. or more and 450° C. or less for 1 to 30 hours; and a second heating stage of heating the ingot at a temperature of more than 450° C. and 560° C. or less for 1 to 20 hours after the first heating stage.

### Advantageous Effects of Invention

The aluminum alloy substrate for a magnetic disk according to the present disclosure is excellent in plating property and grindability. As a result, a storage capacity per magnetic disk can be increased, and the aluminum alloy substrate for a magnetic disk, enabling the improvement of production efficiency and cost reduction, can be provided.

### DESCRIPTION OF EMBODIMENTS

The present disclosure will be described in detail below based on embodiments. The features of the present disclosure include the addition of Mn, the relaxation of the upper limits of the contents of Fe and Si, the content of Cl in a Mg raw material, and the conditions of homogenization heat treatment. The effects and detailed mechanisms of such features will be described below.

1. Mechanism of Generation of Defects on Plated Surface

1-1. Melting of Aluminum Alloy Substrate

Defects on a plated surface are related to melting of an aluminum alloy substrate. The melting of the aluminum alloy substrate is caused by cell reaction between a matrix and intermetallic compounds in steps from pretreatment to electroless Ni—P plating. Al—Fe-based and Al—Si-based intermetallic compounds present on a surface of the aluminum alloy substrate exhibit more electropositive potentials than the potential of a matrix. In other words, a local cell is formed in which the intermetallic compounds are cathode sites and the peripheral matrix is an anode site. The kinds of defects on a plated surface, generated by the reaction of such a local cell, are two. The first defects are defects on a plated surface, generated by allowing the melting of the matrix in the peripheries of the intermetallic compounds to proceed due to local cell reaction in the pretreatment step and by allowing the intermetallic compounds to fall off to form large holes on the surface of the aluminum substrate, thereby disabling electroless Ni—P plating from allowing the holes to be filled. The second defects are defects generated in a case in which local cell reaction occurs in the electroless Ni—P plating step. When the aluminum alloy substrate is exposed in the electroless Ni—P plating step, the melting of the matrix in the peripheries of the intermetallic compounds proceeds due to the local cell reaction, and the local generation of gas continuously occurs, thereby generating the defects on the plated surface, extending from the aluminum substrate to a Ni—P-plated surface and having high aspect ratios.

1-2. Influence of Compounds on Surface of Aluminum Alloy Substrate on Grinding Work

Defects on a plated surface are also related to the falling-off of a compound from a surface of an aluminum alloy substrate in grinding work. A coarse compound such as an intermetallic compound described later or a Cr oxide may fall off in grinding work when being present on the surface of the aluminum alloy substrate. When the compound falls off, large holes are formed in an aluminum alloy surface substrate, thereby disabling electroless Ni—P plating from allowing the holes to be filled, whereby defects on a plated surface are formed. Moreover, when a hard compound is present, it may be impossible to cut the hard compound in grinding work, and projections may be generated on the aluminum alloy surface substrate or grinding flaws starting from the compound may be widely generated, thereby deteriorating the smoothness of the plated surface. Further, the Al—Fe-based intermetallic compound may also cause the melting of the surface of the aluminum substrate to proceed due to local cell reaction, thereby forming large holes as defects. However, since the Al—Fe-based intermetallic compound has, for example, the effect of preventing clogging of a grindstone used in the grinding work, a smaller amount of the Al—Fe-based intermetallic compound results in the clogging of the grindstone and in a lower grinding work rate. The dispersion of a larger amount of the Al—Fe-based intermetallic compound is required for increasing the grinding work rate. The amount of the present Al—Fe-based intermetallic compound is adjusted so that both the prevention of generation of defects on the plated surface and the prevention of a decrease in grinding work rate can be achieved.

2. Aluminum Alloy Substrate

2-1. Content and Effect of Each Element

Mg: 2.0 to 10.0 Mass %

Mg principally has the effect of improving the strength of an aluminum alloy substrate. Moreover, Mg exhibits the action of uniformly, thinly, and minutely depositing a zincate coating film in zincate treatment and therefore inhibits defects from being generated on a plated surface in an electroless Ni—P plating step to improve the smoothness of a Ni—P plated surface. The content of Mg is set at 2.0 to 10.0 mass % (hereinafter, simply referred to as “%”). A Mg content of less than 2.0% results in insufficient strength, while a Mg content of more than 10.0% results in generation of a coarse Mg—Si-based compound, which falls off in cutting work and grinding work, thereby causing defects on a plated surface. As a result, the smoothness of the plated surface is deteriorated. The preferred content of Mg is 4.0 to 6.0% in view of a balance between strength and the easiness of production.

Cu: 0.003 to 0.150%

Cu has the effect of reducing the amount of Al melted in zincate treatment and uniformly, thinly, and minutely depositing a zincate coating film. As a result, defects are inhibited from being generated on a plated surface in an electroless Ni—P plating step to improve the smoothness of the Ni—P-plated surface. The content of Cu is set at 0.003 to 0.150%. A Cu content of less than 0.003% prevents the above-described effect from being sufficiently obtained. In contrast, a Cu content of more than 0.150% results in generation of a coarse Al—Cu—Mg—Zn-based intermetallic compound, which falls off in cutting work and grinding work, thereby causing generation of defects on a plated surface and further deteriorating the corrosion resistance of a material itself, whereby an aluminum alloy substrate is inhomogeneously melted. The preferred content of Cu is 0.010 to 0.100%.

Zn: 0.05 to 0.60%

Like Cu, Zn has the effect of reducing the amount of Al melted in zincate treatment and uniformly, thinly, and minutely depositing a zincate coating film. As a result, defects are inhibited from being generated on a plated surface in an electroless Ni—P plating step to improve the smoothness of the Ni—P-plated surface. The content of Zn is set at 0.05 to 0.60%. A Zn content of less than 0.05% prevents the above-described effect from being sufficiently obtained. In contrast, a Zn content of more than 0.60% results in generation of a coarse Al—Cu—Mg—Zn-based intermetallic compound and in inhomogeneous reaction in the zincate treatment, thereby causing generation of defects on a plated surface and further deteriorating the corrosion resistance of a material itself, whereby an aluminum alloy substrate is inhomogeneously melted. The preferred content of Zn is 0.10 to 0.35%.

Mn: 0.03 to 1.00%

Mn allows Al—Fe-based and Al—Si-based intermetallic compounds precipitated in an aluminum alloy substrate to be precipitated as an Al—Fe—Mn-based intermetallic compound and an Al—Si—Mn-based intermetallic compound, respectively. The aluminum alloy substrate can be inhibited from being melted because potential differences between these intermetallic compounds and a matrix are small, and local cell reaction is inhibited. The content of Mn is set at 0.03 to 1.00%. A Mn content of less than 0.03% prevents such an effect from being sufficiently obtained. A Mn content of more than 1.00% results in generation of coarse Al—Fe—Mn-based and Al—Si—Mn-based intermetallic compounds or an Al—Fe—Mn—Si-based intermetallic compound, which fall off, thereby leading to generation of large holes causing generation of defects on a plated surface. The preferred content of Mn is 0.10 to 0.80%. In addition, the above-described effect is further enhanced in a case in which the content of Mn satisfies a relational expression of Mn, Fe, and Si contents described later.

Be: 0.00001 to 0.00200%

Be has the effect of inhibiting the molten metal oxidation of Mg in casting. However, since Be is a metal of which the potential is more electronegative than that of Al, the formation of a Be-concentrated phase on a surface of an aluminum alloy substrate results in the formation of a local cell between the Be condensed phase and a matrix. As a result, the Be-concentrated phase is considered to be melted, thereby resulting in the inhomogeneous substitution reaction of Ni—P and the continuous occurrence of local generation of gas, as a result of which defects are generated on a plated surface. The content of Be is set at 0.00001 to 0.00200%. A Be content of less than 0.00001% prevents the effect of inhibiting the molten metal oxidation of Mg in casting from being sufficiently obtained, thereby precluding casting. In contrast, a Be content of more than 0.00200% results in the formation of a large amount of the Be-concentrated phase, thereby causing generation of defects on the plated surface. The preferred content of Be is 0.00003 to 0.00100%.

Fe: 0.50% or Less

Fe is hardly solid-dissolved in aluminum and is present as an Al—Fe-based intermetallic compound in an aluminum base metal. Since Fe present in the aluminum is bonded to Al which is an essential element of the present disclosure and generates an Al—Fe-based intermetallic compound causing generation of defects on a plated surface, it is not preferable that Fe is contained in an aluminum alloy. However, the Al—Fe-based intermetallic compound has the dressing effect of inhibiting clogging of a grindstone in a step of grinding an aluminum alloy substrate. Accordingly, the dispersion of a large amount of the Al—Fe-based intermetallic compound in the aluminum alloy substrate is required for improving a grinding work rate. When Mn is added, an Al—Fe—Mn-based intermetallic compound having a small potential difference from a matrix is precipitated, and therefore, local cell reaction can be inhibited to inhibit the melting of the aluminum alloy substrate. When a large amount of the Al—Fe—Mn-based intermetallic compound is precipitated, the dressing effect is exhibited while the melting of the aluminum alloy substrate is inhibited, and therefore, the grinding work rate can be improved. An Fe content of more than 0.50% results in generation of a coarse Al—Fe—Mn-based or Al—Fe—Mn—Si-based intermetallic compound and in falling-off of such an intermetallic compound, thereby leading to generation of large holes causing defects to be generated on the plated surface. Accordingly, the content of Fe content is restricted to 0.50% or less. A smaller Fe content results in the more inhibition of the generation of the defects on the plated surface but in the deterioration of productivity due to a less grinding work rate. An Fe content of 0.01% or more is preferred for improving the grinding work rate. An Fe content set at 0.01 to 0.20% is preferred for improving the grinding work rate while inhibiting the generation of the defects on the plated surface.

Si: 0.50% or Less

Si is bonded to Al, thereby generating an Al—Si-based intermetallic compound causing generation of defects on a plated surface, and therefore, it is not preferable that Si is contained in an aluminum alloy. However, when Mn is added, an Al—Si—Mn-based intermetallic compound having a small potential difference from a matrix is precipitated, and therefore, local cell reaction can be inhibited to inhibit the melting of an aluminum alloy substrate. A Si content of more than 0.50% results in generation of a coarse Al—Si—Mn-based or Al—Fe—Mn—Si-based intermetallic compound and in falling-off of such an intermetallic compound, thereby leading to generation of large holes causing defects to be generated on the plated surface. Accordingly, the content of Si is restricted to 0.50% or less. The content of Si is preferably restricted to less than 0.20% and most preferably restricted to 0.03% or less.

Cr: 0.30% or Less

Cr results in generation of a fine intermetallic compound in casting but is partly solid-dissolved in a matrix to contribute to improvement in strength. Moreover, Cr has the effect of enhancing machinability and grindability and further allowing a recrystallized structure to be fine to improve the adhesiveness of a plated layer. The content of Cr is restricted to 0.30% or less. A Cr content of more than 0.300% results in generation of a coarse Al—Cr-based intermetallic compound while resulting in crystallization of surplus Cr in casting. The crystallized surplus Cr results in the inhomogeneity of reaction in zincate treatment, and the coarse Al—Cr-based intermetallic compound falls off in cutting work and grinding work, thereby causing defects to be generated on a plated surface. Moreover, the larger content of Cr results in the nonnegligible influence of a Cr oxide mixed from a raw material. When a large amount of Cr oxide is present in a material, the Cr oxide falls off in etching, in zincate treatment, and in cutting work and grinding work, thereby generating large holes, causing defects to be generated on the plated surface. The preferred content of Cr is 0.20% or less.

Cl: 0.005% or Less

When the content of Cl is large, Cl is bonded to Mg which is an essential element of the present disclosure and is partly present as a Mg—Cl-based compound. Thus, Cl is brought as the Mg—Cl-based compound from a Mg raw material into an aluminum alloy substrate. A Cl-based compound including a Mg—Cl-based compound has very high solubility and is dissolved upon contact with an aqueous solution environment. When Cl⁻ is released due to the dissolution, the concentration of Cl⁻ locally becomes high, pitting corrosion occurs on a surface of an aluminum alloy substrate, and the aluminum alloy substrate is melted. Once the pitting corrosion occurs, pitting corrosion reaction continues to occur. Therefore, the occurrence of the pitting corrosion on the surface of the aluminum alloy substrate in an early stage of in electroless Ni—P plating results in the inhomogeneous substitution reaction of Ni—P due to the melting of the aluminum alloy substrate and in the continuous occurrence of local generation of gas. As a result, defects are generated on a plated surface. It is considered that the small content of Cl prevents such defects on the plated surface as described above from being generated while the large content of Cl causes defects on the plated surface to be frequently generated. The content of Cl in the aluminum alloy substrate is restricted to 0.005% or less. A Cl content of more than 0.005% results in formation of a Mg—Cl-based compound and therefore causes defects to be generated on the plated surface in plating treatment, thereby deteriorating the smoothness of the plated surface. The content of Cl is preferably restricted to 0.002% or less. The content of Cl in an aluminum alloy is measured by glow discharge mass spectrometry (GDMS). The GDMS measurement was performed by argon sputtering using VG 9000 Type from VG⋅ELEMENTAL Corporation, as a measurement device, under conditions of a discharge voltage of 1.0 kV, a discharge current of 2 mA, and an acceleration voltage of 8.3 kV.

Other Elements

In addition, the balance of the aluminum alloy according to the present disclosure consists of aluminum and unavoidable impurities. In such a case, the characteristics of the aluminum alloy substrate obtained in the present disclosure are not deteriorated when each and the total of the unavoidable impurities (for example, V, and the like) are 0.03% or less and 0.15% or less, respectively.

2-2. Presence Density of Al—Fe—Mn—Si-Based Intermetallic Compound Having Longest Diameter of 10 μm or More of 1.00 Particle/cm² or Less

In the present disclosure, the presence density of an Al—Fe—Mn—Si-based intermetallic compound having a longest diameter of 10 μm or more is set at 1 particle/cm² or less. In such a case, the Al—Fe—Mn—Si-based intermetallic compound defined in the present disclosure refers to an inclusion that can be confirmed to contain Al, Fe, Mn, and Si by WDS analysis in EPMA. In a planar image of the Al—Fe—Mn—Si-based intermetallic compound, obtained by WDS analysis in EPMA, a maximum value of the distance between one point on a contour and another point on the contour is measured, such maximum values with regard to all the points on the contour are measured, and the highest value selected from all the maximum values is defined as the longest diameter.

Defects can be further inhibited from being generated on a plated surface by setting, at 1 particle/cm² or less, the presence density of an Al—Fe—Mn—Si-based intermetallic compound having a longest diameter of 10 μm or more in an aluminum alloy substrate. The Al—Fe—Mn—Si-based intermetallic compound is hard and therefore remains as projections on a surface of the aluminum alloy substrate without being sufficiently ground in grinding work. Moreover, grinding flaws starting from the Al—Fe—Mn—Si-based intermetallic compound are widely generated in the grinding work. Accordingly, the state of the dispersion of the Al—Fe—Mn—Si-based intermetallic compound can be confirmed by visual observation of the projections and the grinding flaws. The projections on the surface of the aluminum alloy substrate cause projections to be also generated on the plated surface. Moreover, the grinding flaws on the surface of the aluminum alloy substrate cause defects to be also generated on the plated surface. The presence density of the Al—Fe—Mn—Si-based intermetallic compound having a longest diameter of 10 μm or more is preferably 0.50 particle/cm² or less, and most preferably 0 particle/cm².

The reason why the longest diameter of the Al—Fe—Mn—Si-based intermetallic compound is limited to 10 μm or more is because an Al—Fe—Mn—Si-based intermetallic compound having a longest diameter of less than 10 μm is insufficiently ground in grinding work and has no influence on a plated surface even if remaining as projections on a surface of an aluminum alloy. Moreover, the upper limit of the longest diameter is not particularly limited; however, an Al—Fe—Mn—Si-based intermetallic compound having a longest diameter of more than 25 μm is not observed in view of the composition and production conditions of the aluminum alloy.

2-3. 0.25≤Mn Content (%)/(Si Content (%)+Fe Content (%))≤1.00

As described above, Mn inhibits melting of an aluminum alloy substrate by precipitating Al—Fe-based and Al—Si-based intermetallic compounds precipitated in an aluminum alloy substrate as an Al—Fe—Mn-based intermetallic compound and an Al—Si—Mn-based intermetallic compound, respectively. However, the just enough addition of Mn with respect to Si and Fe is required for obtaining such an inhibition effect. When Mn content (%)/(Si content (%)+Fe content (%)) is less than 0.25, large amounts of the Al—Fe-based intermetallic compound and the Al—Si-based intermetallic compound are precipitated, and the melting of the aluminum alloy substrate proceeds, thereby causing defects to be generated on a plated surface. When Mn content (%)/(Si content (%)+Fe content (%)) is more than 1.00, coarse Al—Fe—Mn-based, Al—Si—Mn-based, and Al—Fe—Mn—Si-based intermetallic compounds are precipitated and fall off, thereby leading to generation of large holes causing defects to be generated on the plated surface. The above-described expression is preferably 0.35<Mn content (%)/(Si content (%)+Fe content (%))<0.80.

2-4. Other Compounds

In addition to an Al—Fe-based intermetallic compound, an Al—Fe—Mn-based intermetallic compound, an Al—Si-based intermetallic compound, an Al—Si—Mn-based intermetallic compound, and an Al—Fe—Mn—Si-based intermetallic compound, a Cr oxide may be contained in the aluminum alloy substrate according to the present disclosure. As described above, the Cr oxide falls off in etching, in zincate treatment, and in cutting work and grinding work, thereby generating large holes, causing defects to be generated on a plated surface. In the present disclosure, the Cr oxide is not particularly set; however, the presence density of a Cr oxide having a longest diameter of 10 μm or more is preferably set at less than 1 particle/10 cm², and more preferably set at 0 particle/10 cm².

In such a case, a Cr oxide refers to an inclusion that can be confirmed to contain Cr and O by WDS analysis in an electron probe microanalyzer (EPMA). In a planar image of the Cr oxide, obtained by WDS analysis in EPMA, a maximum value of the distance between one point on a contour and another point on the contour is measured, such maximum values with regard to all the points on the contour are measured, and the highest value selected from all the maximum values is defined as the longest diameter.

By setting, at less than 1 particle/10 cm², the presence density of a Cr oxide having a longest diameter of 10 μm or more in an aluminum alloy substrate, the generation of large holes and grinding flaws on a surface of the substrate can be reduced in grinding work and plating pretreatment to prevent defects from being generated on a plated surface and to obtain a smooth plated surface. When a Cr oxide is present on a surface of the aluminum alloy substrate, grinding flaws starting from such inclusions are widely generated in grinding work, and therefore, the state of the dispersion of the Cr oxide can be confirmed by visual observation.

The reason why the longest diameter of the Cr oxide is limited to 10 μm or more is because a Cr oxide having a longest diameter of less than 10 μm has no influence on a plated surface even if falling off from a surface of an aluminum alloy substrate. Moreover, the upper limit of the longest diameter is not particularly limited; however, a Cr oxide having a longest diameter of more than 20 μm is not observed in view of the composition and production conditions of an aluminum alloy.

3. Method of Producing Aluminum Alloy Substrate for Magnetic Disk

A method of producing the aluminum alloy substrate for a magnetic disk according to the present disclosure will now be described.

3-1. Molten Metal Adjustment Step

First, a molten aluminum alloy is adjusted to have a predetermined alloy composition range. In the adjustment of the molten aluminum alloy, a Mg raw material having a Cl content of 0.05% or less is used. The Mg raw material refers to a Mg base metal. Depending on the amount of Mg component in an aluminum alloy, the Mg raw material is added in casting. A Cl content of more than 0.05% in the Mg raw material results in a Cl content of more than 0.005% in an aluminum alloy substrate in the case of producing an aluminum alloy containing 10% of Mg and therefore causes generation of plating pits as described above. The lower limit of the content of Cl in the Mg raw material is not particularly set, but it is preferable to minimize the content.

Further, the amount of Cr oxide in a material can be reduced by using a Cr raw material in which the amount of Cr oxide is 0.50% or less. The Cr raw material refers to a Cr base metal. A Cr oxide amount of more than 0.50% in the Cr raw material allows a large amount of coarse Cr oxide to be present in the material. The presence of a large amount of such coarse Cr oxide in the material allows the Cr oxide to fall off in etching, in zincate treatment, and in cutting work and grinding work, thereby generating large holes, causing defects to be generated on a plated surface. The amount of Cr oxide in the Cr raw material is preferably 0.10% or less. Cr is commonly obtained by heat reduction of a Cr oxide with Al or the like; however, since the rate of the reduction is not 100%, an unreduced Cr oxide is included in the Cr raw material. The removal of the Cr oxide to less than 0.0001% from the Cr raw material results in a higher production cost, and therefore, the lower limit of the amount of Cr oxide in the Cr raw material is set at around 0.0001%.

3-2. Casting Step

The molten aluminum alloy adjusted in the molten metal adjustment step is cast according to a usual method such as semi-continuous casting (DC casting) method. A cooling rate in the casting is preferably set at 0.1° C./s or more. A cooling rate of less than 0.1° C./s results in generation of coarse intermetallic compounds and therefore causes the intermetallic compounds to continuously fall off, thereby generating large recesses, in cutting work and grinding work, thereby deteriorating the smoothness of the plated surface. The upper limit value of the above-described cooling rate is not particularly limited but is logically determined depending on the ability of a casting device, and is set at 0.5° C./s in the present disclosure.

3-3. Homogenization Treatment Step

An ingot obtained by the casting is subjected to homogenization treatment. The homogenization treatment includes two heating stages. In the first heating stage, the ingot is heat-treated at a temperature of 400° C. or more and 450° C. or less for 1 to 30 hours, preferably at a temperature of 410° C. or more and 440° C. or less for 3 to 20 hours. The nucleation of an Al—Fe—Mn—Si-based intermetallic compound is promoted by the homogenization treatment in the first stage. In the case of a heat treatment temperature of less than 400° C. or a heat treatment time of less than 1 hour, the nucleation does not occur sufficiently. As a result, a coarse Al—Fe—Mn—Si-based intermetallic compound is generated in the subsequent second heating stage. In the case of a heat treatment temperature of more than 450° C., a coarse Al—Fe—Mn—Si-based intermetallic compound is generated. Even the heat treatment performed for a heat treatment time of more than 30 hours results in saturation of such an effect and therefore in insufficient economical efficiency.

After the first heating stage, the ingot is subjected to the second heating stage. In the second heating stage, the ingot is heat-treated at a temperature of more than 450° C. and 560° C. or less for 1 to 20 hours, preferably at a temperature of 460 or more and 550° C. or less for 3 to 15 hours. The solid dissolution of Mg₂Si by the homogenization treatment in the second stage inhibits generation of large holes causing defects to be generated on the plated surface. In the homogenization treatment in the second heating stage, the Al—Fe—Mn—Si-based intermetallic compound generated in the homogenization treatment in the first heating stage grows; however, when nucleation sufficiently occurs in the homogenization treatment in the first heating stage, a coarse Al—Fe—Mn—Si-based intermetallic compound is not formed. In the case of a heat treatment temperature of 450° C. or less or a heat treatment time of less than 1 hour, Mg₂Si is not sufficiently solid-dissolved. In the case of a heat treatment temperature of more than 560° C., the ingot may be melted. Even the heat treatment performed for a heat treatment time of more than 20 hours results in saturation of such an effect and therefore in insufficient economical efficiency.

3-4. Hot-Rolling Step

After the homogenization treatment step, the ingot is hot-rolled. The conditions of the hot rolling are not limited, but, for example, a hot-rolling start temperature is preferably set at 350 to 500° C., and a hot-rolling end temperature is preferably set at 260 to 380° C.

3-5. Cold-Rolling Step

The hot-rolled sheet subjected to the hot rolling is finished to have a required product sheet thickness by cold rolling. The conditions of the cold rolling are not particularly limited but may be set depending on needed product sheet strength and a needed sheet thickness, and, for example, rolling reduction is preferably set at 20 to 90%. Before or in the cold rolling, annealing treatment may be further performed preferably at a temperature of 280 to 450° C., preferably for 0 to 10 hours, to secure cold-rolling workability. In such a case, an annealing time of 0 hours means that the annealing is ended immediately after the annealing temperature has been reached. The aluminum alloy substrate for a magnetic disk is produced in such a manner as described above.

4. Method of Producing Magnetic Disk

A magnetic disk is produced using the aluminum alloy substrate for a magnetic disk produced in such a manner as described above. First, an aluminum alloy substrate is stamped to have an annular shape to prepare an annular aluminum alloy substrate for a magnetic disk. Then, the annular aluminum alloy substrate for a magnetic disk is subjected to pressurization annealing at 300 to 450° C. for 30 minutes or more to prepare a flattened disk blank.

The disk blank flattened in such a manner is subjected to working treatment including cutting work, grinding work, and, preferably, strain-removing heat treatment at a temperature of 300 to 400° C. for 5 to 15 minutes in the order mentioned above to produce a substrate for a magnetic disk. Then, the substrate for a magnetic disk is subjected to degreasing treatment, etching treatment, and zincate treatment in the order mentioned above as plating pretreatment.

In the degreasing treatment, degreasing is preferably performed under conditions of a temperature of 40 to 70° C., a treatment time of 3 to 10 minutes, and a concentration of 200 to 800 mL/L by using commercially available AD-68F (manufactured by C. Uyemura & Co., Ltd.) degreasing liquid or the like. In the etching treatment, etching is preferably performed under conditions of a temperature 50 to 75° C., a treatment time of 0.5 to 5 minutes, and a concentration of 20 to 100 mL/L by using commercially available AD-107F (manufactured by C. Uyemura & Co., Ltd.) etching liquid or the like. Usual desmut treatment may be performed between the etching treatment and the zincate treatment described later. The zincate treatment is preferably performed under conditions of a temperature of 10 to 35° C., a treatment time of 0.1 to 5 minutes, and a concentration of 100 to 500 mL/L by using commercially available AD-301F-3X (manufactured by C. Uyemura & Co., Ltd.) zincate treatment liquid or the like.

A surface of the substrate for a magnetic disk subjected to the zincate treatment is subjected to electroless Ni—P plating treatment as undercoat plating treatment. As the electroless Ni—P plating treatment, plating treatment is preferably performed under conditions of a temperature of 80 to 95° C., a treatment time of 30 to 180 minutes, and a Ni concentration of 3 to 10 g/L by using commercially available NIMUDEN HDX (manufactured by C. Uyemura & Co., Ltd.) plating liquid or the like. The aluminum alloy substrate for a magnetic disk, subjected to the undercoat treatment, of the present disclosure is obtained by the plating pretreatment and electroless Ni—P plating treatment described above. Finally, a magnetic substance is deposited on the surface subjected to the undercoat plating treatment by sputtering to make the magnetic disk.

### EXAMPLES

The present disclosure will be described in more detail below with reference to Examples. However, the present disclosure is not limited thereto.

First, each aluminum alloy with component composition set forth in Tables 1 to 3 was melted to make a molten aluminum alloy according to a usual method. Then, the molten aluminum alloy was cast by a DC casting method, to produce an ingot. Both surfaces of the ingot were faced in 15 mm, and the ingot was subjected to homogenization treatment under conditions set forth in Tables 1 to 3. In a homogenization treatment step in the tables, time where an ingot has a constant or varying temperature of 400° C. or more and 450° C. or less was regarded as retention time in a first heating stage, and time where the ingot has a constant or varying temperature of more than 450° C. and 560° C. or less was regarded as retention time in a second heating stage. Then, the ingot was hot-rolled at a hot-rolling start temperature of 460° C. and a hot-rolling end temperature of 340° C. to make a hot-rolled sheet having a sheet thickness of 3.0 mm. The hot-rolled sheet was rolled to have a sheet thickness of 1.0 mm by cold rolling (rolling reduction of 66.6%) without being subjected to intermediate annealing, to make a final rolled sheet. In contrast to the above, in Present Disclosure Example 32, an ingot was cold-rolled (rolling reduction of 33.3%) and then subjected to intermediate annealing using a batch-type annealing furnace under conditions of 300° C. and 2 hours. Then, the ingot was rolled to have a final sheet thickness of 1.0 mm by second cold rolling (rolling reduction of 50.0%). The aluminum alloy sheet obtained in such a manner was stamped to have an annular shape having an outer diameter of 96 mm and an inner diameter of 24 mm to produce an annular aluminum alloy sheet.

TABLE 1

| | | | | | | | | | | | | Homogenization Treatment Step | | | | | |
|---|---|---|---|---|---|---|---|---|---|---|---|---|---|---|---|---|---|
| | | | | | | | | | | | | First Heating | Second Heating | Presence Density | | | |
| | | | | | | | | | | | | Stage | Stage | | Al—Fe—Mn—Si-Based | | |
| | | | | | | | | | | Mn/(Si + Fe) | Amount of Cr Oxide | Retention Time | Retention Time | Cr Oxide | Intermetallic | Grinding | Evaluation |
| | Alloy Composition (mass %) | | | | | | | | | (mass %/ | in Cr Raw Material | at 400 to 450° C. | at 450 to 560° C. | (particle/ | Compound | Rate | of Plated |
| | Mg | Cu | Zn | Be | Mn | Cr | Si | Fe | Cl | mass %) | (mass %) | (h) | (h) | 10 cm²) | (particle/cm²) | (μm/min) | Surface |
| Present | 2.0 | 0.050 | 0.30 | 0.00100 | 0.20 | 0.06 | 0.10 | 0.20 | 0.003 | 0.67 | 0.10 | 6 | 8 | 0 | 0.25 | 23.5 | Excellent |
| Disclosure | | | | | | | | | | | | | | | | | |
| Example 1 | | | | | | | | | | | | | | | | | |
| Present | 10.0 | 0.050 | 0.30 | 0.00100 | 0.20 | 0.06 | 0.10 | 0.20 | 0.003 | 0.67 | 0.10 | 6 | 8 | 0 | 0.31 | 23.0 | Excellent |
| Disclosure | | | | | | | | | | | | | | | | | |
| Example 2 | | | | | | | | | | | | | | | | | |
| Present | 5.0 | 0.003 | 0.30 | 0.00100 | 0.20 | 0.06 | 0.10 | 0.20 | 0.003 | 0.67 | 0.10 | 6 | 8 | 0 | 0.30 | 24.1 | Excellent |
| Disclosure | | | | | | | | | | | | | | | | | |
| Example 3 | | | | | | | | | | | | | | | | | |
| Present | 5.0 | 0.150 | 0.30 | 0.00100 | 0.20 | 0.06 | 0.10 | 0.20 | 0.003 | 0.67 | 0.10 | 6 | 8 | 0 | 0.24 | 23.0 | Excellent |
| Disclosure | | | | | | | | | | | | | | | | | |
| Example 4 | | | | | | | | | | | | | | | | | |
| Present | 5.0 | 0.050 | 0.05 | 0.00100 | 0.20 | 0.06 | 0.10 | 0.20 | 0.003 | 0.67 | 0.10 | 6 | 8 | 0 | 0.20 | 22.8 | Excellent |
| Disclosure | | | | | | | | | | | | | | | | | |
| Example 5 | | | | | | | | | | | | | | | | | |
| Present | 5.0 | 0.050 | 0.60 | 0.00100 | 0.20 | 0.06 | 0.10 | 0.20 | 0.003 | 0.67 | 0.10 | 6 | 8 | 0 | 0.41 | 23.2 | Excellent |
| Disclosure | | | | | | | | | | | | | | | | | |
| Example 6 | | | | | | | | | | | | | | | | | |
| Present | 5.0 | 0.050 | 0.30 | 0.00001 | 0.20 | 0.06 | 0.10 | 0.20 | 0.003 | 0.67 | 0.10 | 6 | 8 | 0 | 0.40 | 23.6 | Excellent |
| Disclosure | | | | | | | | | | | | | | | | | |
| Example 7 | | | | | | | | | | | | | | | | | |
| Present | 5.0 | 0.050 | 0.30 | 0.00200 | 0.20 | 0.06 | 0.10 | 0.20 | 0.003 | 0.67 | 0.10 | 6 | 8 | 0 | 0.31 | 23.1 | Excellent |
| Disclosure | | | | | | | | | | | | | | | | | |
| Example 8 | | | | | | | | | | | | | | | | | |
| Present | 5.0 | 0.050 | 0.30 | 0.00100 | 0.03 | 0.06 | 0.05 | 0.05 | 0.003 | 0.30 | 0.10 | 6 | 8 | 0 | 0.00 | 20.1 | Excellent |
| Disclosure | | | | | | | | | | | | | | | | | |
| Example 9 | | | | | | | | | | | | | | | | | |
| Present | 5.0 | 0.050 | 0.30 | 0.00100 | 1.00 | 0.06 | 0.50 | 0.50 | 0.003 | 1.00 | 0.10 | 6 | 8 | 0 | 0.95 | 29.3 | Good |
| Disclosure | | | | | | | | | | | | | | | | | |
| Example 10 | | | | | | | | | | | | | | | | | |
| Present | 5.0 | 0.050 | 0.30 | 0.00100 | 0.20 | 0.03 | 0.10 | 0.20 | 0.003 | 0.67 | 0.10 | 6 | 8 | 0 | 0.32 | 22.6 | Excellent |
| Disclosure | | | | | | | | | | | | | | | | | |
| Example 11 | | | | | | | | | | | | | | | | | |
| Present | 5.0 | 0.050 | 0.30 | 0.00100 | 0.20 | 0.30 | 0.10 | 0.20 | 0.003 | 0.67 | 0.10 | 6 | 8 | 0.3 | 0.40 | 23.3 | Excellent |
| Disclosure | | | | | | | | | | | | | | | | | |
| Example 12 | | | | | | | | | | | | | | | | | |
| Present | 5.0 | 0.050 | 0.30 | 0.00100 | 0.20 | 0.06 | 0.05 | 0.20 | 0.003 | 0.80 | 0.10 | 6 | 8 | 0 | 0.75 | 24.3 | Excellent |
| Disclosure | | | | | | | | | | | | | | | | | |
| Example 13 | | | | | | | | | | | | | | | | | |
| Present | 5.0 | 0.050 | 0.30 | 0.00100 | 0.50 | 0.06 | 0.50 | 0.10 | 0.003 | 0.83 | 0.10 | 6 | 8 | 0 | 0.50 | 21.2 | Excellent |
| Disclosure | | | | | | | | | | | | | | | | | |
| Example 14 | | | | | | | | | | | | | | | | | |
| Present | 5.0 | 0.050 | 0.30 | 0.00100 | 0.10 | 0.06 | 0.10 | 0.03 | 0.003 | 0.77 | 0.10 | 6 | 8 | 0 | 0.61 | 20.3 | Excellent |
| Disclosure | | | | | | | | | | | | | | | | | |
| Example 15 | | | | | | | | | | | | | | | | | |
| Present | 5.0 | 0.050 | 0.30 | 0.00100 | 0.50 | 0.06 | 0.10 | 0.50 | 0.003 | 0.83 | 0.10 | 6 | 8 | 0 | 0.50 | 25.7 | Excellent |
| Disclosure | | | | | | | | | | | | | | | | | |
| Example 16 | | | | | | | | | | | | | | | | | |
| Present | 5.0 | 0.050 | 0.30 | 0.00100 | 0.15 | 0.06 | 0.10 | 0.10 | 0.002 | 0.75 | 0.10 | 6 | 8 | 0 | 0.44 | 21.6 | Excellent |
| Disclosure | | | | | | | | | | | | | | | | | |
| Example 17 | | | | | | | | | | | | | | | | | |
| Present | 5.0 | 0.050 | 0.30 | 0.00100 | 0.15 | 0.06 | 0.03 | 0.20 | 0.005 | 0.65 | 0.10 | 6 | 8 | 0 | 0.34 | 22.2 | Excellent |
| Disclosure | | | | | | | | | | | | | | | | | |
| Example 18 | | | | | | | | | | | | | | | | | |
| Present | 5.0 | 0.050 | 0.30 | 0.00100 | 0.50 | 0.06 | 0.25 | 0.30 | 0.003 | 0.91 | 0.10 | 6 | 8 | 0 | 0.53 | 22.1 | Excellent |
| Disclosure | | | | | | | | | | | | | | | | | |
| Example 19 | | | | | | | | | | | | | | | | | |
| Present | 5.0 | 0.050 | 0.30 | 0.00100 | 0.30 | 0.06 | 0.10 | 0.50 | 0.003 | 0.50 | 0.10 | 6 | 8 | 0 | 0.23 | 24.4 | Good |
| Disclosure | | | | | | | | | | | | | | | | | |
| Example 20 | | | | | | | | | | | | | | | | | |
| Present | 5.0 | 0.050 | 0.30 | 0.00100 | 0.07 | 0.06 | 0.05 | 0.10 | 0.003 | 0.47 | 0.10 | 6 | 8 | 0 | 0.20 | 21.1 | Good |
| Disclosure | | | | | | | | | | | | | | | | | |
| Example 21 | | | | | | | | | | | | | | | | | |
| Present | 5.0 | 0.050 | 0.30 | 0.00100 | 0.20 | 0.06 | 0.20 | 0.40 | 0.003 | 0.33 | 0.10 | 6 | 8 | 0 | 0.71 | 23.5 | Good |
| Disclosure | | | | | | | | | | | | | | | | | |
| Example 22 | | | | | | | | | | | | | | | | | |
| Present | 5.0 | 0.050 | 0.30 | 0.00100 | 0.04 | 0.06 | 0.03 | 0.02 | 0.003 | 0.80 | 0.30 | 6 | 8 | 0.1 | 0.00 | 18.5 | Excellent |
| Disclosure | | | | | | | | | | | | | | | | | |
| Example 23 | | | | | | | | | | | | | | | | | |
| Present | 5.0 | 0.050 | 0.30 | 0.00100 | 0.25 | 0.06 | 0.10 | 0.20 | 0.003 | 0.83 | 0.50 | 6 | 8 | 0.15 | 0.21 | 22.8 | Excellent |
| Disclosure | | | | | | | | | | | | | | | | | |
| Example 24 | | | | | | | | | | | | | | | | | |
| Present | 5.0 | 0.050 | 0.30 | 0.00100 | 0.05 | 0.06 | 0.03 | 0.03 | 0.003 | 1.00 | 0.10 | 6 | 8 | 0 | 0.80 | 19.2 | Good |
| Disclosure | | | | | | | | | | | | | | | | | |
| Example 25 | | | | | | | | | | | | | | | | | |

TABLE 2

| | | | | | | | | | | | | Homogenization Treatment Step | | Presence Density | | | |
|---|---|---|---|---|---|---|---|---|---|---|---|---|---|---|---|---|---|
| | | | | | | | | | | Mn/ | Amount of | First Heating | Second Heating | | Al—Fe—Mn—Si- | | |
| | | | | | | | | | | (Si + Fe) | Cr Oxide in Cr | Stage | Stage | Cr Oxide | Based Intermetallic | Grinding | Evaluation |
| | Alloy Composition (mass %) | | | | | | | | | (mass %/ | Raw Material | Retention Time | Retention Time | (particle/ | Compound | Rate | of Plated |
| | Mg | Cu | Zn | Be | Mn | Cr | Si | Fe | Cl | mass %) | (mass %) | at 400 to 450° C. (h) | at 450 to 560° C. (h) | 10 cm²) | (particle/cm²) | (μm/min) | Surface |
| Comparative | 1.0 | 0.050 | 0.30 | 0.00100 | 0.20 | 0.06 | 0.10 | 0.20 | 0.003 | 0.67 | 0.10 | 6 | 8 | 0 | 0.36 | 22.1 | Poor |
| Example 1 | | | | | | | | | | | | | | | | | |
| Comparative | 12.0 | 0.050 | 0.30 | 0.00100 | 0.20 | 0.06 | 0.10 | 0.20 | 0.003 | 0.67 | 0.10 | 6 | 8 | — | — | — | — |
| Example 2 | | | | | | | | | | | | | | | | | |
| Comparative | 5.0 | 0.001 | 0.30 | 0.00100 | 0.20 | 0.06 | 0.10 | 0.20 | 0.003 | 0.67 | 0.10 | 6 | 8 | 0 | 0.33 | 22.0 | Poor |
| Example 3 | | | | | | | | | | | | | | | | | |
| Comparative | 5.0 | 0.300 | 0.30 | 0.00100 | 0.20 | 0.06 | 0.10 | 0.20 | 0.003 | 0.67 | 0.10 | 6 | 8 | 0 | 0.41 | 23.2 | Poor |
| Example 4 | | | | | | | | | | | | | | | | | |
| Comparative | 5.0 | 0.050 | 0.01 | 0.00100 | 0.20 | 0.06 | 0.10 | 0.20 | 0.003 | 0.67 | 0.10 | 6 | 8 | 0 | 0.32 | 23.2 | Poor |
| Example 5 | | | | | | | | | | | | | | | | | |
| Comparative | 5.0 | 0.050 | 0.80 | 0.00100 | 0.20 | 0.06 | 0.10 | 0.20 | 0.003 | 0.67 | 0.10 | 6 | 8 | 0 | 0.30 | 22.9 | Poor |
| Example 6 | | | | | | | | | | | | | | | | | |
| Comparative | 5.0 | 0.050 | 0.05 | 0.00000 | 0.20 | 0.06 | 0.10 | 0.20 | 0.003 | 0.67 | 0.10 | 6 | 8 | — | — | — | — |
| Example 7 | | | | | | | | | | | | | | | | | |
| Comparative | 5.0 | 0.050 | 0.05 | 0.00400 | 0.20 | 0.06 | 0.10 | 0.20 | 0.003 | 0.67 | 0.10 | 6 | 8 | 0 | 0.40 | 23.0 | Poor |
| Example 8 | | | | | | | | | | | | | | | | | |
| Comparative | 5.0 | 0.050 | 0.30 | 0.00100 | 1.20 | 0.06 | 0.10 | 0.20 | 0.003 | 4.00 | 0.10 | 6 | 8 | 0 | 12.00 | 17.7 | Poor |
| Example 9 | | | | | | | | | | | | | | | | | |
| Comparative | 5.0 | 0.050 | 0.30 | 0.00100 | 0.20 | 0.50 | 0.10 | 0.20 | 0.003 | 0.67 | 0.10 | 6 | 8 | 2 | 0.33 | 22.0 | Poor |
| Example 10 | | | | | | | | | | | | | | | | | |
| Comparative | 5.0 | 0.050 | 0.30 | 0.00100 | 0.20 | 0.06 | 0.70 | 0.20 | 0.003 | 0.22 | 0.10 | 6 | 8 | 0 | 0.10 | 14.1 | Poor |
| Example 11 | | | | | | | | | | | | | | | | | |
| Comparative | 5.0 | 0.050 | 0.30 | 0.00100 | 0.20 | 0.06 | 0.10 | 0.70 | 0.003 | 0.25 | 0.10 | 6 | 8 | 0 | 0.03 | 25.8 | Poor |
| Example 12 | | | | | | | | | | | | | | | | | |
| Comparative | 5.0 | 0.050 | 0.30 | 0.00100 | 0.20 | 0.06 | 0.10 | 0.20 | 0.010 | 0.67 | 0.10 | 6 | 8 | 0 | 0.30 | 22.5 | Poor |
| Example 13 | | | | | | | | | | | | | | | | | |
| Comparative | 5.0 | 0.050 | 0.30 | 0.00100 | 0.15 | 0.06 | 0.40 | 0.40 | 0.003 | 0.19 | 0.10 | 6 | 8 | 0 | 0.10 | 20.0 | Poor |
| Example 14 | | | | | | | | | | | | | | | | | |
| Comparative | 5.0 | 0.050 | 0.30 | 0.00100 | 1.00 | 0.06 | 0.40 | 0.40 | 0.003 | 1.25 | 0.10 | 6 | 8 | 0 | 3.00 | 17.5 | Poor |
| Example 15 | | | | | | | | | | | | | | | | | |
| Comparative | 5.0 | 0.050 | 0.30 | 0.00100 | 1.00 | 0.06 | 0.20 | 0.20 | 0.003 | 2.50 | 0.10 | 6 | 8 | 0 | 10.00 | 16.7 | Poor |
| Example 16 | | | | | | | | | | | | | | | | | |
| Comparative | 5.0 | 0.050 | 0.30 | 0.00100 | 0.50 | 0.06 | 0.03 | 0.03 | 0.003 | 8.33 | 0.10 | 6 | 8 | 0 | 21.00 | 15.2 | Poor |
| Example 17 | | | | | | | | | | | | | | | | | |
| Comparative | 5.0 | 0.050 | 0.30 | 0.00100 | 0.00 | 0.06 | 0.03 | 0.03 | 0.003 | 0.00 | 0.10 | 6 | 8 | 0 | 0.00 | 17.2 | Good |
| Example 18 | | | | | | | | | | | | | | | | | |
| Comparative | 5.0 | 0.050 | 0.30 | 0.00100 | 0.03 | 0.06 | 0.10 | 0.10 | 0.003 | 0.15 | 0.10 | 6 | 8 | 0 | 0.00 | 18.0 | Poor |
| Example 19 | | | | | | | | | | | | | | | | | |
| Comparative | 5.0 | 0.050 | 0.30 | 0.00100 | 0.80 | 0.06 | 0.10 | 0.30 | 0.003 | 2.00 | 0.10 | 6 | 8 | 0 | 5.00 | 18.2 | Poor |
| Example 20 | | | | | | | | | | | | | | | | | |
| Comparative | 5.0 | 0.050 | 0.30 | 0.00100 | 0.01 | 0.06 | 0.01 | 0.01 | 0.003 | 0.50 | 0.10 | 6 | 8 | 0 | 0.00 | 17.2 | Excellent |
| Example 21 | | | | | | | | | | | | | | | | | |
| Comparative | 5.0 | 0.050 | 0.30 | 0.00100 | 0.20 | 0.06 | 0.10 | 0.20 | 0.003 | 0.67 | 0.80 | 6 | 8 | 5 | 0.24 | 21.3 | Poor |
| Example 22 | | | | | | | | | | | | | | | | | |

TABLE 3

| | | | | | | | | | | | | Homogenization Treatment Step | | | | | |
|---|---|---|---|---|---|---|---|---|---|---|---|---|---|---|---|---|---|
| | | | | | | | | | | | | First | Second | Presence Density | | | |
| | | | | | | | | | | | Amount of | Heating Stage | Heating Stage | | Al—Fe—Mn—Si- | | |
| | | | | | | | | | | | Cr Oxide in Cr | Retention Time | Retention Time | | Based Intermetallic | Grinding | Evaluation |
| | Alloy Composition (mass %) | | | | | | | | | Mn/(Si + Fe) | Raw Material | at 400 to | at 450 to | Cr Oxide | Compound | Rate | of Plated |
| | Mg | Cu | Zn | Be | Mn | Cr | Si | Fe | Cl | (mass %/mass %) | (mass %) | 450° C. (h) | 560° C. (h) | (particle/10 cm²) | (particle/cm²) | (μm/min) | Surface |
| Present | 5.0 | 0.050 | 0.30 | 0.00100 | 0.20 | 0.06 | 0.10 | 0.20 | 0.003 | 0.67 | 0.10 | 1 | 8 | 0 | 0.61 | 23.2 | Excellent |
| Disclosure | | | | | | | | | | | | | | | | | |
| Example 26 | | | | | | | | | | | | | | | | | |
| Present | 5.0 | 0.050 | 0.30 | 0.00100 | 0.20 | 0.06 | 0.10 | 0.20 | 0.003 | 0.67 | 0.10 | 15 | 8 | 0 | 0.43 | 23.7 | Excellent |
| Disclosure | | | | | | | | | | | | | | | | | |
| Example 27 | | | | | | | | | | | | | | | | | |
| Present | 5.0 | 0.050 | 0.30 | 0.00100 | 0.20 | 0.06 | 0.10 | 0.20 | 0.003 | 0.67 | 0.10 | 30 | 8 | 0 | 0.31 | 23.6 | Excellent |
| Disclosure | | | | | | | | | | | | | | | | | |
| Example 28 | | | | | | | | | | | | | | | | | |
| Present | 5.0 | 0.050 | 0.30 | 0.00100 | 0.20 | 0.06 | 0.10 | 0.20 | 0.003 | 0.67 | 0.10 | 6 | 1 | 0 | 0.31 | 23.3 | Excellent |
| Disclosure | | | | | | | | | | | | | | | | | |
| Example 29 | | | | | | | | | | | | | | | | | |
| Present | 5.0 | 0.050 | 0.30 | 0.00100 | 0.20 | 0.06 | 0.10 | 0.20 | 0.003 | 0.67 | 0.10 | 6 | 10 | 0 | 0.24 | 23.2 | Excellent |
| Disclosure | | | | | | | | | | | | | | | | | |
| Example 30 | | | | | | | | | | | | | | | | | |
| Present | 5.0 | 0.050 | 0.30 | 0.00100 | 0.20 | 0.06 | 0.10 | 0.20 | 0.003 | 0.67 | 0.10 | 6 | 20 | 0 | 0.20 | 23.2 | Excellent |
| Disclosure | | | | | | | | | | | | | | | | | |
| Example 31 | | | | | | | | | | | | | | | | | |
| Present | 2.0 | 0.050 | 0.30 | 0.00100 | 0.20 | 0.06 | 0.10 | 0.20 | 0.003 | 0.67 | 0.10 | 6 | 8 | 0 | 0.24 | 23.4 | Excellent |
| Disclosure | | | | | | | | | | | | | | | | | |
| Example 32*¹⁾ | | | | | | | | | | | | | | | | | |
| Comparative | 5.0 | 0.050 | 0.30 | 0.00100 | 0.20 | 0.06 | 0.10 | 0.20 | 0.003 | 0.67 | 0.10 | 0.5 | 8 | 0 | 15.70 | 21.6 | Poor |
| Example 23 | | | | | | | | | | | | | | | | | |
| Comparative | 5.0 | 0.050 | 0.30 | 0.00100 | 0.20 | 0.06 | 0.10 | 0.20 | 0.003 | 0.67 | 0.10 | 40 | 8 | 0 | 0.20 | 24.3 | Good |
| Example 24 | | | | | | | | | | | | | | | | | |
| Comparative | 5.0 | 0.050 | 0.30 | 0.00100 | 0.20 | 0.06 | 0.10 | 0.20 | 0.003 | 0.67 | 0.10 | 6 | 0.5 | 0 | 0.46 | 23.1 | Poor |
| Example 25 | | | | | | | | | | | | | | | | | |
| Comparative | 5.0 | 0.050 | 0.30 | 0.00100 | 0.20 | 0.06 | 0.10 | 0.20 | 0.003 | 0.67 | 0.10 | 6 | 30 | 0 | 0.12 | 23.8 | Good |
| Example 26 | | | | | | | | | | | | | | | | | |
| Comparative | 5.0 | 0.050 | 0.30 | 0.00100 | 0.20 | 0.06 | 0.10 | 0.20 | 0.003 | 0.67 | 0.10 | 0.5*²⁾ | 8 | 0 | 16.30 | 20.3 | Poor |
| Example 27 | | | | | | | | | | | | | | | | | |
| Comparative | 5.0 | 0.050 | 0.30 | 0.00100 | 0.20 | 0.06 | 0.10 | 0.20 | 0.003 | 0.67 | 0.10 | 6 | 8*³⁾ | — | — | — | — |
| Example 28 | | | | | | | | | | | | | | | | | |
| Comparative | 5.0 | 0.050 | 0.30 | 0.00100 | 0.20 | 0.06 | 0.10 | 0.20 | 0.003 | 0.67 | 0.10 | 30*²⁾ | 0.5 | 0 | 0.30 | 23.0 | Poor |
| Example 29 | | | | | | | | | | | | | | | | | |
| Comparative | 5.0 | 0.050 | 0.30 | 0.00100 | 0.20 | 0.06 | 0.10 | 0.20 | 0.003 | 0.67 | 0.10 | 6 | 10*⁴⁾ | 0 | 0.44 | 22.9 | Poor |
| Example 30 | | | | | | | | | | | | | | | | | |

*¹⁾The intermediate annealing was performed in the cold rolling.
*²⁾The ingot was retained at a temperature of 300 to 390° C. for 15 hours prior to the first heating stage.
*³⁾A heating temperature in the second heating stage was set at 600° C. *⁴⁾A heating temperature in the second heating stage was set at 400° C

The annular aluminum alloy sheet obtained in such a manner as described above was subjected to pressurization flattening annealing under a pressure of 1.5 MPa at 400° C. for 3 hours to make a disk blank. Further, an end surface of the disk blank was subjected to cutting work, so that the disk blank had an outer diameter of 95 mm and an inner diameter of 25 mm. Further, grinding work in which the surface was ground in 10 μm was performed. Then, the disk blank was subjected to strain-removing heat treatment at 350° C. for 10 minutes.

Then, the aluminum alloy sheet subjected to the strain-removing heat treatment was subjected to plating pretreatment. First, the aluminum alloy sheet was degreased with AD-68F (manufactured by C. Uyemura & Co., Ltd.) at 60° C. for 5 minutes, then etched with AD-107F (manufactured by C. Uyemura & Co., Ltd.) at 65° C. for 3 minutes, and further desmutted with 30% HNO₃ aqueous solution (room temperature) at room temperature for 50 seconds. Then, zincate treatment of the aluminum alloy sheet was performed with a zincate treatment liquid (AD-301F, manufactured by C. Uyemura & Co., Ltd.) at 25° C. for 50 seconds. After the zincate treatment, a zincate layer was peeled with a 30% HNO₃ aqueous solution (room temperature) for 60 seconds, and zincate treatment was performed again with a zincate treatment liquid (AD-301F, manufactured by C. Uyemura & Co., Ltd.) at 25° C. for 60 seconds.

The surface of the aluminum alloy substrate, subjected to the second zincate treatment, was electroless plated with Ni—P of 17 μm in thickness using an electroless Ni—P plating treatment liquid (NIMUDEN HDX, manufactured by C. Uyemura & Co., Ltd.) at 90° C. for 120 minutes and then subjected to final polishing (polishing quantity of 4 μm) by a fabric.

Evaluation 1: Presence Density of Al—Fe—Mn—Si-Based Intermetallic Compound

The surface of the aluminum alloy sheet, subjected to the grinding work, the number of particles per disk (6597 mm²) was measured while identifying an Al—Fe—Mn—Si-based intermetallic compound having a longest diameter of 10 μm or more by an observation image of EPMA and WDS analysis (wavelength dispersion-type X-ray analysis), and was converted into a presence density (particle/cm²). When an Al—Fe—Mn—Si-based intermetallic compound is present on a substrate surface, grinding flaws starting from such inclusions are widely generated in grinding work, and therefore, the dispersion state of the inclusions can be confirmed by visual observation. The results are set forth in Tables 1 to 3.

Evaluation 2: Measurement of Grinding Work Rate

The disk blank was placed in a 9B grinding work machine and subjected to grinding work in two steps of Step 1 (a pressure of 100 MPa, a footwall rotation number of 2 rpm, a sun gear rotation number of 5 rpm, a grinding fluid flow rate of 3 L/min, and a time of 10 s) and Step 2 (a pressure of 200 MPa, a footwall rotation number of 30 rpm, a sun gear rotation number of 10 rpm, a grinding fluid flow rate of 3 L/min, and a time of 20 s). A grinding work rate (μm/min) was calculated from a difference between the sheet thicknesses of the disk blank before and after the grinding work. A grinding work rate of 18 (μm/min) or more was regarded as acceptable, while a grinding work rate of less than 18 (μm/min) was regarded as unacceptable. The results are set forth in Tables 1 to 3.

Evaluation 3: Measurement of Number of Defects on Plated Surface

The aluminum alloy substrate subjected to the final polishing was immersed in 50% by volume of nitric acid at 50° C. for 3 minutes to etch the Ni—P plated surface. Five visual fields of the etched surface of the aluminum alloy substrate were photographed using an SEM at a magnification of 5000 times. The area of one visual field was set at 536 μm². The numbers of crater-like defects and pits were measured based on the photographs of the five visual fields, and the arithmetic mean value of the five visual fields was determined. A case in which the arithmetic mean value was less than 5 per visual field was evaluated as “Excellent”, a case in which the arithmetic mean value was 5 or more and less than 10 per visual field was evaluated as “Good”, and a case in which the arithmetic mean value was 10 or more per visual field was regarded as “Poor”. The results are set forth as the evaluation of the plated surface in Tables 1 to 3. “Excellent” and “Good” were regarded as acceptable, while “Poor” was regarded as unacceptable.

Evaluation Results

In Present Disclosure Examples 1 to 32, the presence density of Al—Fe—Mn—Si and the evaluation result of a plated surface were acceptable because the alloy composition and the production conditions were within the scope of the present disclosure.

In Comparative Example 1, a zincate coating film was inhomogeneous, and the number of defects on a plated surface was large because the content of Mg was small. Thus, Comparative Example 1 was evaluated as unacceptable. Moreover, Comparative Example 1 resulted in insufficient strength and was unacceptable for use for a product.

In Comparative Example 2, the content of Mg was large, and therefore, cracking occurred in hot rolling, thereby disabling sampling.

In Comparative Example 3, a zincate coating film was inhomogeneous, and the number of defects on a plated surface was large because the content of Cu was small. Thus, Comparative Example 3 was evaluated as unacceptable.

In Comparative Example 4, the melting of an aluminum alloy substrate was inhomogeneous due to holes caused by the falling-off of a coarse intermetallic compound and the deterioration of the corrosion resistance of a material itself because the content of Cu was large. Therefore, the number of defects on a plated surface was large, and Comparative Example 4 was evaluated as unacceptable.

In Comparative Example 5, a zincate coating film was inhomogeneous, and the number of defects on a plated surface was large because the content of Zn was small. Thus, Comparative Example 5 was evaluated as unacceptable.

In Comparative Example 6, the melting of an aluminum alloy substrate was inhomogeneous due to holes caused by the falling-off of a coarse intermetallic compound and the deterioration of the corrosion resistance of a material itself. Therefore, the number of defects on a plated surface was large, and Comparative Example 6 was evaluated as unacceptable.

In Comparative Example 7, Be was not contained, and therefore, oxidation on a surface of an ingot became severe, thereby disabling sampling.

In Comparative Example 8, the content of Be was large, and therefore, a large amount of Be-concentrated phase was formed. Local generation of gas in Ni—P reaction continuously occurred due to cell reaction between the Be-condensed phase and a matrix, and the number of defects on a plated surface was large. Thus, Comparative Example 8 was evaluated as unacceptable.

In Comparative Example 9, the content of Mn was large, and therefore, a coarse intermetallic compound was generated and fell off, thereby generating defects on a plated surface and resulting in a large number of defects on the plated surface. Thus, Comparative Example 9 was evaluated as unacceptable.

In Comparative Example 10, the content of Cr was large, and therefore, the influence of a Cr oxide did not become negligible. The Cr oxide fell off, thereby generating large holes and resulting in a large number of defects on a plated surface. Thus, Comparative Example 10 was evaluated as unacceptable.

In Comparative Example 11, the content of Si was large, and therefore, a coarse intermetallic compound was generated and fell off, thereby resulting in a large number of defects on a plated surface. Thus, Comparative Example 11 was evaluated as unacceptable. In addition, Comparative Example 11 resulted in a low grinding rate, thereby also causing the deterioration of productivity.

In Comparative Example 12, the content of Fe was large, and therefore, a coarse intermetallic compound was generated and fell off, thereby resulting in a large number of defects on a plated surface. Thus, Comparative Example 12 was evaluated as unacceptable.

In Comparative Example 13, the content of Cl in an added Mg raw material was as much as 0.08%, and therefore, the content of Cl in an aluminum alloy was also as much as 0.010%. As a result, a large amount of Mg—Cl-based compound was mixed into an aluminum alloy, and the concentration of Cl was locally increased, thereby causing pitting corrosion to occur on a surface of an aluminum alloy substrate. As a result, local generation of gas in Ni—P reaction continuously occurred, thereby resulting in a large number of defects on a plated surface. Thus, Comparative Example 13 was evaluated as unacceptable.

In Comparative Examples 14 to 20, a relationship of Mn content (%)/(Si content (%)+Fe content (%)) was not satisfied, and therefore, the number of defects on a plated surface became large and/or a grinding rate was decreased, thereby also resulting in the deterioration of productivity. Thus, Comparative Examples 14 to 20 were evaluated as unacceptable.

Comparative Example 21 resulted in a small number of defects on a plated surface and was evaluated as acceptable. However, since the contents of Si and Fe were small, the rate of high-purity base metal was increased, thereby resulting in an increase in cost for industrial production. Moreover, a grinding rate became low, thereby also resulting in the deterioration of productivity.

In Comparative Example 22, the amount of Cr oxide in a Cr raw material was large, and therefore, the Cr oxide fell off, thereby generating large holes and resulting in a large number of defects on a plated surface. Thus, Comparative Example 22 was evaluated as unacceptable.

In Comparative Example 23, the conditions of the first phase homogenization treatment were out of the scope of the present disclosure, and therefore, the presence density of an Al—Fe—Mn—Si-based intermetallic compound was increased, thereby a large number of defects on a plated surface. Thus, Comparative Example 23 was evaluated as unacceptable.

Comparative Example 24 resulted in the long time of the first homogenization treatment and was unsuitable for industrial production.

In Comparative Example 25, the conditions of the second homogenization treatment were out of the scope of the present disclosure, and therefore, Mg₂Si was not sufficiently solid-dissolved, thereby resulting in a large number of defects on a plated surface. Thus, Comparative Example 25 was evaluated as unacceptable.

Comparative Example 26 resulted in the long time of the second homogenization treatment and was unsuitable for industrial production.

In Comparative Example 27, the first homogenization treatment was performed after retainment at a temperature of 300 to 390° C. for 15 hours. However, Comparative Example 27 resulted in the short time of the first homogenization treatment and therefore in the increased presence density of an Al—Fe—Mn—Si-based intermetallic compound, thereby resulting in a large number of defects on a plated surface. Thus, Comparative Example 27 was evaluated as unacceptable.

Comparative Example 28 resulted in the high temperature of the second homogenization treatment and therefore in melting of a part of an ingot, thereby disabling sampling.

In Comparative Example 29, the first homogenization treatment and the second homogenization treatment were performed after retainment at a temperature of 300 to 390° C. for 15 hours. However, Comparative Example 29 resulted in the short time of the second homogenization treatment and therefore in insufficient solid dissolution of Mg₂Si, thereby resulting in a large number of defects on a plated surface. Thus, Comparative Example 29 was evaluated as unacceptable.

Comparative Example 30 resulted in the low temperature of the second homogenization treatment and therefore in insufficient solid dissolution of Mg₂Si, thereby resulting in a large number of defects on a plated surface. Thus, Comparative Example 30 was evaluated as unacceptable.

### INDUSTRIAL APPLICABILITY

The substrate for a magnetic disk and the aluminum alloy substrate for a magnetic disk according to the present disclosure are excellent in plating property and grindability. As a result, a storage capacity per magnetic disk can be increased, and productivity can be improved.

1. An aluminum alloy substrate for a magnetic disk, the aluminum alloy substrate comprising 2.0 to 10.0 mass % of Mg, 0.003 to 0.150 mass % of Cu, 0.05 to 0.60 mass % of Zn, 0.03 to 1.00 mass % of Mn, and 0.00001 to 0.00200 mass % of Be, as well as Fe restricted to 0.50 mass % or less, Si restricted to 0.50 mass % or less, Cr restricted to 0.30 mass % or less, and Cl restricted to 0.005 mass % or less, with a balance of Al and unavoidable impurities.

2. The aluminum alloy substrate according to claim 1, wherein an Al—Fe—Mn—Si-based intermetallic compound having a longest diameter of 10 μm or more is present at a density of 1.00 particle/cm² or less.

3. The aluminum alloy substrate according to claim 1, wherein 0.25≤Mn content (mass %)/(Si content (mass %)+Fe content (mass %))≤1.00 is satisfied.

4. A method of producing the aluminum alloy substrate according to claim 1, the method comprising: a molten metal adjustment step of adding a Mg raw material having a Cl content of 0.05 mass % or less to adjust a molten metal of an aluminum alloy; a casting step of casting the adjusted molten metal to obtain an ingot; a homogenization treatment step of homogenizing the cast ingot by heat treatment; a hot-rolling step of hot-rolling the ingot subjected to the homogenization treatment, to obtain a hot-rolled sheet; and a cold-rolling step of cold-rolling the hot-rolled sheet, wherein the homogenization treatment step comprises: a first heating stage of heating the ingot at a temperature of 400° C. or more and 450° C. or less for 1 to 30 hours; and a second heating stage of heating the ingot at a temperature of more than 450° C. and 560° C. or less for 1 to 20 hours after the first heating stage.

5. The aluminum alloy substrate according to claim 2, wherein 0.25≤Mn content (mass %)/(Si content (mass %)+Fe content (mass %))≤1.00 is satisfied.

6. A method of producing the aluminum alloy substrate according to claim 2, the method comprising: a molten metal adjustment step of adding a Mg raw material having a Cl content of 0.05 mass % or less to adjust a molten metal of an aluminum alloy; a casting step of casting the adjusted molten metal to obtain an ingot; a homogenization treatment step of homogenizing the cast ingot by heat treatment; a hot-rolling step of hot-rolling the ingot subjected to the homogenization treatment, to obtain a hot-rolled sheet; and a cold-rolling step of cold-rolling the hot-rolled sheet, wherein the homogenization treatment step comprises: a first heating stage of heating the ingot at a temperature of 400° C. or more and 450° C. or less for 1 to 30 hours; and a second heating stage of heating the ingot at a temperature of more than 450° C. and 560° C. or less for 1 to 20 hours after the first heating stage.

7. A method of producing the aluminum alloy substrate according to claim 3, the method comprising: a molten metal adjustment step of adding a Mg raw material having a Cl content of 0.05 mass % or less to adjust a molten metal of an aluminum alloy; a casting step of casting the adjusted molten metal to obtain an ingot; a homogenization treatment step of homogenizing the cast ingot by heat treatment; a hot-rolling step of hot-rolling the ingot subjected to the homogenization treatment, to obtain a hot-rolled sheet; and a cold-rolling step of cold-rolling the hot-rolled sheet, wherein the homogenization treatment step comprises: a first heating stage of heating the ingot at a temperature of 400° C. or more and 450° C. or less for 1 to 30 hours; and a second heating stage of heating the ingot at a temperature of more than 450° C. and 560° C. or less for 1 to 20 hours after the first heating stage.

8. A method of producing the aluminum alloy substrate according to claim 5, the method comprising: a molten metal adjustment step of adding a Mg raw material having a Cl content of 0.05 mass % or less to adjust a molten metal of an aluminum alloy; a casting step of casting the adjusted molten metal to obtain an ingot; a homogenization treatment step of homogenizing the cast ingot by heat treatment; a hot-rolling step of hot-rolling the ingot subjected to the homogenization treatment, to obtain a hot-rolled sheet; and a cold-rolling step of cold-rolling the hot-rolled sheet, wherein the homogenization treatment step comprises: a first heating stage of heating the ingot at a temperature of 400° C. or more and 450° C. or less for 1 to 30 hours; and a second heating stage of heating the ingot at a temperature of more than 450° C. and 560° C. or less for 1 to 20 hours after the first heating stage.
